(19) United States
(12) Patent Application Publication
(10) Pub. No.: US 2007/0061439 A1
(43) Pub. Date: Mar. 15, 2007

(54) Signalling data reception

(76) Inventors: Steve Leslie Pope, Cambridge (GB); Derek Edwards Roberts, Cambridge (GB); David James Riddoch, Cambridge (GB)

Correspondence Address: WEIDE & MILLER, LTD., 7251 W. LAKE MEAD BLVD., SUITE 530, LAS VEGAS, NV, 89128, US

(21) Appl. No.: 11/584,261

(22) Filed: Oct. 19, 2006

(30) Foreign Application Priority Data
Apr. 21, 2004 (WO) PCT/GB05/01374

(51) Int. Cl. G06F 15/173

(52) U.S. Cl. 709/223

(57) ABSTRACT

A network interface device for connection to a data processing device and to a data network so as to provide an interface between the data processing device and the network for supporting the delivery of packets of a transport protocol, the network interface device being arranged to: transmit at least some of the content of the packets to the data processing device identify within the payloads of the packets data of a further protocol that represent a request to access memory of the data processing device; and on identifying such data apply a signal to a high priority processing function of the data processing device to enable that function to process the data.

### 1. PRIOR APPLICATION DATA

This application claims priority to PCT Application No. PCT/GB2005/001374, entitled Signalling Data Reception which was published as WO 2005/104478 and which is entitled to a priority date of Apr. 21, 2004.

### 2. FIELD OF THE INVENTION

This invention relates to a network interface, for example an interface device for linking a computer to a network.

### SUMMARY

To overcome the drawbacks of the prior art and to provide additional benefits, disclosed herein is a network interface device for connection to a data processing device and to a data network. When configured, this device provides an interface between the data processing device and the network for supporting the delivery of packets of a transport protocol such that the network interface device is configured to transmit at least some of the content of the packets to the data processing device and identify, within the payloads of the packets, data of a further protocol that represent a request to access memory of the data processing device. Upon detecting such data, the device applies a signal to a high priority processing function of the data processing device to enable that function to process the data.

In one embodiment the high priority processing function is part of an operating system of the data processing device. In addition, the high priority processing function may be a kernel of the data processing device. It is contemplated that the signal is an interrupt on the data processing apparatus. The further protocol may be the RDMA (remote direct memory access) or ISCSI (internet small computer serial interface) protocol. It is contemplated that the network interface device may be arranged to transmit the packets to the data processing device by writing the packets to a queue stored by the data processing device. In one embodiment, the at least part of the content comprises the whole of the payload of the packets.

Also disclosed herein is a data processing system comprising a data processing device and a data network. Also part of this embodiment is a network interface device configured to communicate with a data processing device over the data network to thereby transmit at least some of the content of the packets to the data processing device. The network interface device then identifies within the payloads of the packets data of a further protocol that represent a request to access memory of the data processing device and upon identifying such data, applies a signal to a high priority processing function of the data processing device to enable that function to process the data.

In one variation the data processing device has an operating system and the operating system is arranged to accept and action the said signal. The signal may comprise data characterising the request to access memory of the data processing device and the operating system is arranged to action the said signal in accordance with that data. In addition, the data may include data indicating each address at which data is to be accessed.

Also disclosed herein is a method for connecting a network interface device to a data processing device and to a data network so as to provide an interface between the data processing device and the network to support the delivery of packets of a transport protocol. In this embodiment the packets comprise payload. In this embodiment the method comprises transmitting at least some content of the packets to the data processing device and identifying, within the payloads of the packets, data of a further protocol that represents a request to access memory of the data processing device. The method then, upon identifying such data, applies a signal to a high priority processing function of the data processing device to enable that function to process the data.

In one variation of this method the high priority processing function is part of an operating system of the data processing device. The high priority processing function may be a kernel of the data processing device. The signal may comprise an interrupt on the data processing apparatus. It is also contemplated that the further protocol may comprise the RDMA (remote direct memory access) or ISCSI (internet small computer serial interface) protocol. In addition, the network interface device may transmit the packets to the data processing device by writing the packets to a queue stored by the data processing device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The present invention will now be described by way of example with reference to the accompanying drawings. The components in the figures are not necessarily to scale, emphasis instead being placed upon illustrating the principles of the invention. In the figures, like reference numerals designate corresponding parts throughout the different views. The figures are as follows:

FIG. 1 is a schematic diagram of a network interface device in use;

FIG. 2 illustrates an implementation of a transport library architecture;

FIG. 3 shows an architecture employing a standard kernel TCP transport with a user level TCP transport;

FIG. 4 illustrates an architecture in which a standard kernel stack is implemented at user-level; and

FIG. 5 shows an example of a TCP transport architecture.

### DETAILED DESCRIPTION

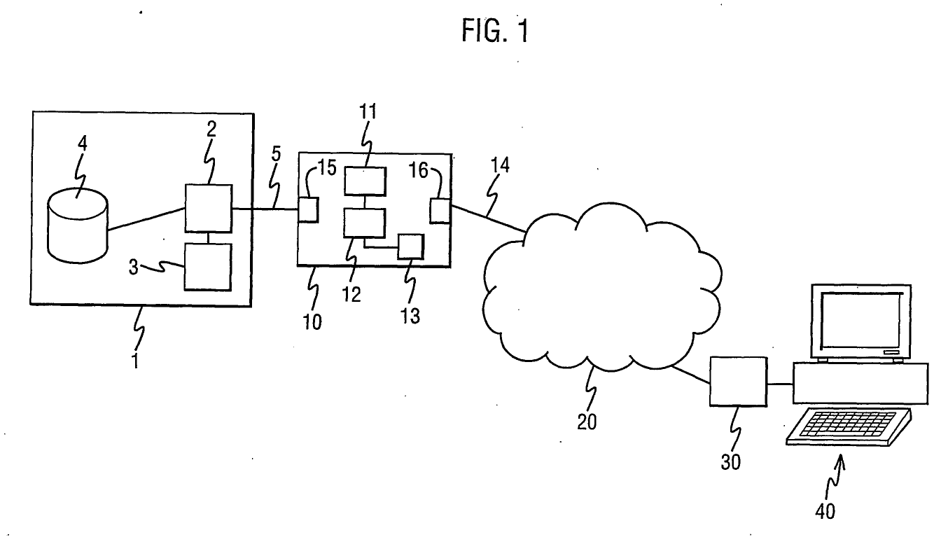

FIG. 1 is a schematic diagram showing a network interface device such as a network interface card (NIC) and the general architecture of the system in which it may be used. The network interface device 10 is connected via a data link 5 to a processing device such as computer 1, and via a data link 14 to a data network 20. Further network interface devices such as processing device 30 are also connected to the network, providing interfaces between the network and further processing devices such as processing device 40.

The computer 1 may, for example, be a personal computer, a server or a dedicated processing device such as a data logger or controller. In this example it comprises a processor 2, a program store 4 and a memory 3. The program store stores instructions defining an operating system and applications that can run on that operating system. The operating system provides means such as drivers and interface libraries by means of which applications can access peripheral hardware devices connected to the computer.

It is desirable for the network interface device to be capable of supporting standard transport protocols such as TCP, RDMA and ISCSI at user level: i.e. in such a way that they can be made accessible to an application program running on computer 1. Such support enables data transfers which require use of standard protocols to be made without requiring data to traverse the kernel stack. In the network interface device of this example standard transport protocols are implemented within transport libraries accessible to the operating system of the computer 1.

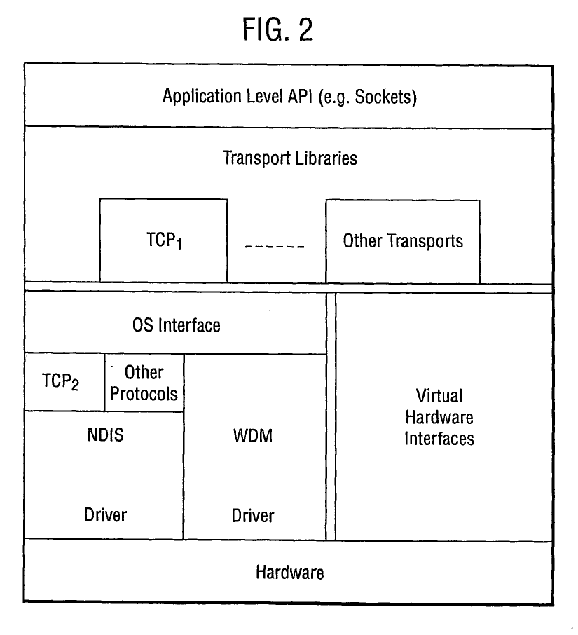

FIG. 2 illustrates one implementation of this. In this architecture the TCP (and other) protocols are implemented twice: as denoted TCP1 and TCP2 in FIG. 2. In a typical operating system TCP2 will be the standard implementation of the TCP protocol that is built into the operating system of the computer. In order to control and/or communicate with the network interface device an application running on the computer may issue API (application programming interface) calls. Some API calls may be handled by the transport libraries that have been provided to support the network interface device. API calls which cannot be serviced by the transport libraries that are available directly to the application can typically be passed on through the interface between the application and the operating system to be handled by the libraries that are available to the operating system. For implementation with many operating systems it is convenient for the transport libraries to use existing Ethernet/IP based control-plane structures: e.g. SNMP and ARP protocols via the OS interface.

There are a number of difficulties in implementing transport protocols at user level. Most implementations to date have been based on porting pre-existing kernel code bases to user level. Examples of these are Arsenic and Jet-stream. These have demonstrated the potential of user-level transports, but have not addressed a number of the problems required to achieve a complete, robust, high-performance commercially viable implementation.

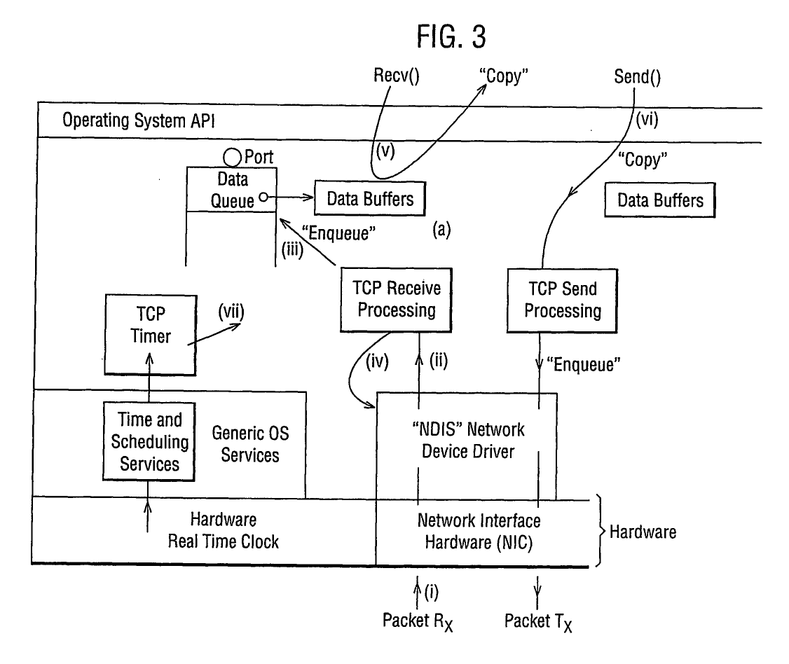

FIG. 3 shows an architecture employing a standard kernel TCP transport (TCPk).

The operation of this architecture is as follows.

On packet reception from the network interface hardware (e.g. a network interface card (NIC)), the NIC transfers data into pre-allocated data buffer (a) and invokes the OS interrupt handler by means of the interrupt line. (Step i). The interrupt handler manages the hardware interface e.g. posts new receive buffers and passes the received (in this case Ethernet) packet looking for protocol information. If a packet is identified as destined for a valid protocol e.g. TCP/IP it is passed (not copied) to the appropriate receive protocol processing block. (Step ii).

TCP receive-side processing takes place and the destination part is identified from the packet. If the packet contains valid data for the port then the packet is engaged on the port's data queue (step iii) and that port marked (which may involve the scheduler and the awakening of blocked process) as holding valid data.

The TCP receive processing may require other pockets to be transmitted (step iv), for example in the cases that previously transmitted data should be retransmitted or that previously enqueued data (perhaps because the TCP window has opened) can now be transmitted. In this case packets are enqueued with the OS “NDIS” driver for transmission.

In order for an application to retrieve a data buffer it must invoke the OS API (step v), for example by means of a call such as recv( ), select( ) or poll( ). This has the effect of informing the application that data has been received and (in the case of a recv( ) call) copying the data from the kernel buffer to the application's buffer. The copy enables the kernel (OS) to reuse its network buffers, which have special attributes such as being DMA accessible and means that the application does not necessarily have to handle data in units provided by the network, or that the application needs to know a priori the final destination of the data, or that the application must pre-allocate buffers which can then be used for data reception.

It should be noted that on the receive side there are at least two distinct threads of control which interact asynchronously: the up-call from the interrupt and the system call from the application. Many operating systems will also split the up-call to avoid executing too much code at interrupt priority, for example by means of “soft interrupt” or “deferred procedure call” techniques.

The send process behaves similarly except that there is usually one path of execution. The application calls the operating system API (e.g. using a send ( ) call) with data to be transmitted (Step vi). This call copies data into a kernel data buffer and invokes TCP send processing. Here protocol is applied and fully formed TCP/IP packets are enqueued with the interface driver for transmission.

If successful, the system call returns with an indication of the data scheduled (by the hardware) for transmission. However there are a number of circumstances where data does not become enqueued by the network interface device. For example the transport protocol may queue pending acknowledgements or window updates, and the device driver may queue in software pending data transmission requests to the hardware.

A third flow of control through the system is generated by actions which must be performed on the passing of time. One example is the triggering of retransmission algorithms. Generally the operating system provides all OS modules with time and scheduling services (driven by the hardware clock interrupt), which enable the TCP stack to implement timers on a per-connection basis.

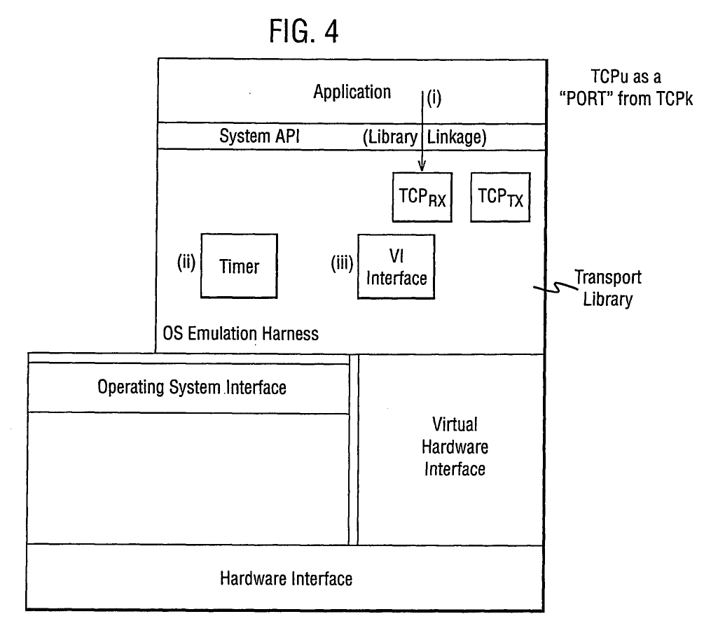

If a standard kernel stack were implemented at user-level then the structure might be generally as shown in FIG. 4. The application is linked with the transport library, rather than directly with the OS interface. The structure is very similar to the kernel stack implementation with services such as timer support provided by user level packages, and the device driver interface replaced with user-level virtual interface module. However in order to provide the model of a asynchronous processing required by the TCP implementation there must be a number of active threads of execution within the transport library:
System API calls provided by the application
Timer generated calls into protocol code
Management of the virtual network interface and resultant upcalls into protocol code.
(ii and iii can be combined for some architectures)

However, this arrangement introduces a number of problems. The overheads of context switching between these threads and implementing locking to protect shared-data structures can be significant, costing a significant amount of processing time.

The user level timer code generally operates by using operating system provided timer/time support. Large overheads caused by system calls from the timer module result in the system failing to satisfy the aim of preventing interaction between the operating system and the data path.

There may be a number of independent applications each of which manages a sub-set of the network connection; some via their own transport libraries and some by existing kernel stack transport libraries. The NIC must be able to efficiently parse packets and deliver them to the appropriate virtual interface (or the OS) based on protocol information such as IP port and host address bits.

It is possible for an application to pass control of a particular network connection to another application for example during a fork( ) system call on a Unix operating system. This requires that a completely different transport library instance would be required to access connection state. Worse, a number of applications may share a network connection which would mean transport libraries sharing ownership via (inter process communication) techniques. Existing transports at user level do not attempt to support this.

It is common for transport protocols to mandate that a network connection outlives the application to which it is tethered. For example using the TCP protocol, the transport must endeavour to deliver sent, but unacknowledged data and gracefully close a connection when a sending application exits or crashes. This is not a problem with a kernel stack implementation that is able to provide the “timer” input to the protocol stack no matter what the state (or existence) of the application, but is an issue for a transport library which will disappear (possibly ungracefilly) if the application exits, crashes, or stopped in a debugger.

Furthermore, RDMA (remote direct memory access) and ISCSI (internet small computer system interface) are protocols that allow one device such as a computer to directly access the contents of the memory of another (“target”) device to which it is connected over a network. The protocols involve embedding in conventional network packets strings of data that define the operations to be performed according to the protocol. For example, to perform an RDMA operation to write data to the memory of a remote computer a TCP packet may be sent to that computer with a payload containing string made up of: a marker marking the start of RDMA data, a tag indicating where in the memory the data is to be written to, the data itself, and a CRC block to allow the integrity of the data to be verified on receipt. A single TCP packet may contain multiple such strings. When the TCP packet is received the data in its payload can be identified as RDMA data and processed accordingly to perform the desired write operation.

The processing of the packet to extract, verify and interpret the RDMA data can be performed by a processor of the target device itself or by a network interface device of the target device. However, it is conventional for the processing to be performed by the network interface device because this allows the passing of the data to and from the memory of the target to be performed efficiently. If the processing were performed by a processor of the target device then two memory write operations would be required since the RDMA data string would first have to be passed to a buffer area of the device's memory for processing, and then—when the destination address of the data had been determined—it would be copied to that address. In contrast, if the RDMA processing is performed on the network interface device then the destination address can be determined there and the data can be written directly to that address, saving the copy operation that would otherwise be required. For this reason the approach of processing RDMA or ISCSI data on the network interface device is preferred. However, it has the disadvantage that it requires the network interface device to have considerable processing power. This increases expense, especially since embedded processing power on devices such as network interface devices is typically more expensive than main processor power.

It would be desirable to provide an enhanced means of supporting protocols such as RDMA and ISCSI.

According to one aspect of the present invention there is provided a network interface device for connection to a data processing device and to a data network so as to provide an interface between the data processing device and the network for supporting the delivery of packets of a transport protocol, the network interface device being arranged to: transmit at least some of the content of the packets to the data processing device; identify within the payloads of the packets data of a further protocol that represent a request to access memory of the data processing device; and on identifying such data apply a signal to a high priority processing function of the data processing device to enable that function to process the data.

The request to access the memory is suitably a read request: i.e. a request to read contents of the memory.

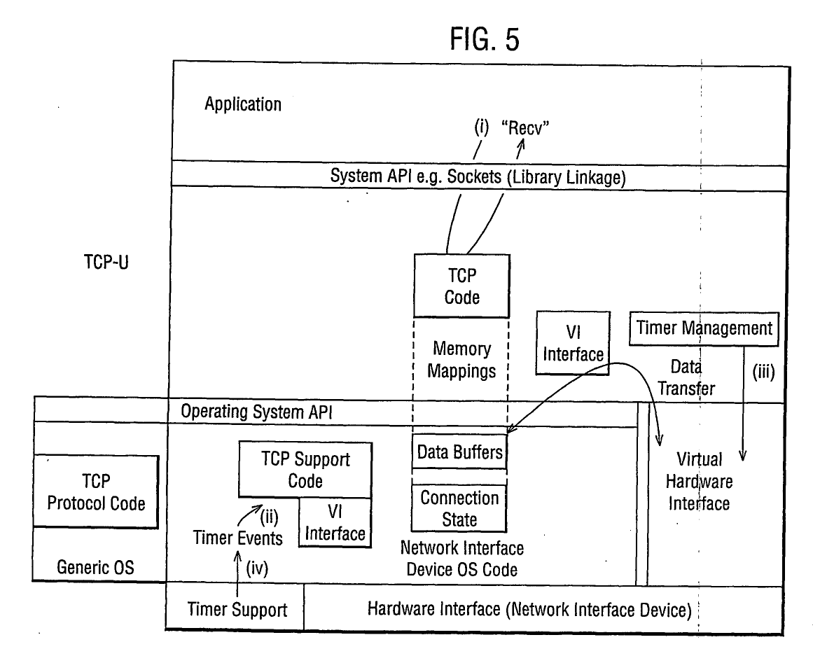

FIG. 5 shows an example of a TCP transport architecture suitable for providing an interface between a network interface device such as device 10 of FIG. 1 and a computer such as computer 1 of FIG. 1. The architecture is not limited to this implementation.

The principal differences between the architecture of the example of FIG. 5 and conventional architectures are as follows.

TCP code which performs protocol processing on behalf of a network connection is located both in the transport library, and in the OS kernel. The fact that this code performs protocol processing is especially significant.

Connection state and data buffers are held in kernel memory and memory mapped into the transport library's address space

Both kernel and transport library code may access the virtual hardware interface for and behalf of a particular network connection

Timers may be managed through the virtual hardware interface, (these correspond to real timers on the network interface device) without requiring system calls to set and clear them. The NIC generates timer events which are received by the network interface device driver and passed up to the TCP support code for the device.

It should be noted that the TCP support code for the network interface device is in addition to the generic OS TCP implementation. This is suitably able to co-exist with the stack of the network interface device.

The effects of this architecture are as follows.

Requirement for Multiple Threads Active in the Transport Library

This requirement is not present for the architecture of FIG. 5 since TCP code can either be executed in the transport library as a result of a system API call (e.g. recvo) (see step i of FIG. 5) or by the kernel as a result of a timer event (see step ii of FIG. 5). In ether case, the VI interface can be managed and both code paths may access connection state or data buffers, whose protection and mutual exclusion may be managed by shared memory locks. As well as allowing the overheads of thread switching at the transport library level to be removed, this feature can prevent the requirement for applications to change their thread and signal-handling assumptions: for example in some situations it can be unacceptable to require a single threaded application to link with a multi-threaded library.

Replacement to Issue System Calls for Timer Management

This requirement is not present for the architecture of FIG. 5 because the network interface device can implement a number of timers which may be allocated to particular virtual interface (VI) instances: for example there may be one timer per active TCP transport library. These timers can be made programmable (see step iii of FIG. 5) through a memory mapped VI and result in events (see step iv of FIG. 5) being issued. Because timers can be set and cleared without a system call the overhead for timer management is greatly reduced.

Correct Delivery of Packets to Multiple Transport Libraries

The network interface device can contain or have access to content addressable memory, which can match bits taken from the headers of incoming packets as a parallel hardware match operation. The results of the match can be taken to indicate the destination virtual interface which must be used for delivery, and the hardware can proceed to deliver the packet onto buffers which have been pushed on the VI. One possible arrangement for the matching process is described below. The arrangement described below could be extended to de-multiplex the larger host addresses associated with IPv6, although this would require a wider CAM or multiple CAM lookups per packet than the arrangement as described.

One alternative to using a CAM for this purpose is to use a hash algorithm that allows data from the packets' headers to be processed to determine the virtual interface to be used.

Handover of Connections Between Processes/Applications/Threads

When a network connection is handed over the same system-wide resource handle can be passed between the applications. This could, for example, be a file descriptor. The architecture of the network interface device can attach all state associated with the network connection with that (e.g.) file descriptor and require the transport library to memory map on to this state. Following a handover of a network connection, the new application (whether as an application, thread or process)—even if it is executing within a different address space—is able to memory-map and continue to use the state. Further, by means of the same backing primitive as used between the kernel and transport library any number of applications are able to share use of a network connection with the same semantics as specified by standard system APIs.

Completion of Transport Protocol Operations When the Transport Library is Ether Stopped or Killed or Quit.

This step can be achieved in the architecture of the network interface device because connection state and protocol code can remain kernel resident. The OS kernel code can be informed of the change of state of an application in the same manner as the generic TCP (TCPk) protocol stack. An application which is stopped will then not provide a thread to advance protocol execution, but the protocol will continue via timer events, for example as is known for prior art kernel stack protocols.

As discussed above, there are a number of newly emerging protocols such as IETF RDMA and iSCSI. At least some of these protocols were designed to run in an environment where the TCP and other protocol code executes on the network interface device. Facilities will now be described whereby the processing to support such protocols can be executed at least partially on a host CPU (i.e. using the processing means of a computer to which a network interface card is connected). Such an implementation is advantageous because it allows a user to take advantage of the price/performance lead of main CPU technology as against co-processors.

Protocols such as RDMA involve the embedding of framing information and cyclic redundancy check (CRC) data within the TCP stream. While framing information is trivial to calculate within protocol libraries, CRC's (in contrast to checksums) are computationally intensive and best done by hardware. To accommodate this, when a TCP stream is carrying an RDMA or similar encapsulation an option in the virtual interface can be is enabled, for example by means of a flag. On detecting this option, the NIC will parse each packet on transmission, recover the RDMA frame, apply the RDMA CRC algorithm and insert the CCRC on the fly during transmission. Analogous procedures can beneficially be used in relation to other protocols, such as iSCSI, that require computationally relatively intensive calculation of error check data.

In line with this system the network interface device can also verify CRCs on received packets using similar logic. This may, for example, be performed in a manner akin to the standard TCP checksum off-load technique.

To execute this arrangement, the steps performed are preferably as follows. When operating in an RDMA compatible mode the NIC analyses the payload of each received TCP packet to identify whether it comprises RDMA data. This may be done by checking whether the RDMA framing data (i.e. the RDMA header and footer) and particularly the RDMA header marker is present in the payload. If it is not present then the packet is processed as normal. If it is present then the payload of the packet is processed by the NIC according to the RDMA CRC algorithm in order to calculate the RDMA CRC for the received data. Once that has been calculated then one of two routes can be employed. In a first route the RDMA data together with the calculated CRC is passed to the host computer. The host computer can then compare the calculated CRC with the CRC as received in the RDMA data to establish whether the data has been correctly received. Alternatively, in a second route that comparison can be performed at the NIC and the RDMA data together with an indication of the result of that comparison (e.g. in a one-bit flag) is passed to the host computer. In either case the host computer can then process the RDMA data accordingly. Thus, if the result of the CRC check indicates that data has been correctly received it can execute the RDMA command represented by the data (typically a read or write command). Otherwise it does not execute the command, and in that case it may automatically perform an error recovery action such as initiating a request for retransmission of the data.

If the NIC performs the checking of the CRC in addition to its calculation then if it determines that the data has not been validly received it need not transmit the payload of the corresponding RDMA data to the host computer. It need only transmit sufficient information from the header of the transport protocol packet (typically a TCP header) and from the RDMA framing information to allow the host computer to request retransmission. It may transmit the whole of that header and framing information or it could transmit just some of that header and framing information. It will be appreciated that this operation is performed on a per-RDMA-data-unit basis. Thus, if a TCP packet contains a single RDMA data unit it is the framing data of that same data unit and the header of that same packet (or part thereof) that are passed to the host computer. If a TCP packet contains multiple RDMA data units then if any RDMA data unit is determined to be bad then its framing data and the header of the entire packet (or part thereof) are transmitted to the host PC.

Protocols such as RDMA also mandate additional operations such as RDMA READ which in conventional implementations require additional intelligence on the network interface device. As indicated above, this type of implementation has led to the general belief that RDMA/TCP should best be implemented by means of a co-processor network interface device. In an architecture of the type described herein, specific hardware filters can be encoded to trap such upper level protocol requests for a particular network connection. In such a circumstance, the NIC can generate an event akin to the timer event in order to request action by software running on the attached computer, as well a delivery data message. By triggering an event in such a way the NIC can achieve the result that either the transport library, or the kernel helper will act on the request immediately. This can avoid the potential problem of kernel extensions not executing until the transport library is scheduled and can be applied to other upper protocols if required.

As indicated above, in a preferred embodiment a network interface card is connected to a host device such as a computer. The host device comprises a processor capable of executing instructions stored in a program store. The instructions define an operating system kernel and one or more applications that are supported by the operating system. An application may be associated with a transport library, which is also defined by instructions stored in the program store, and which provides support for communications between the transport library and the NIC. In a typical implementation the operating system will run continuously whilst the host device is in operation, whereas the transport libraries may be started and stopped and their priorities adjusted. In particular, a transport library may be descheduled, so that it is unresponsive to direct communications from the network interface card, or takes a considerable time to respond.

To enable the NIC to communicate with the kernel and the transport libraries an event queue is provided in the memory space of the host device. The queue can conveniently be allocated in the memory space when the system is being configured, and its location can be provided to and stored by the NIC so that it can access the queue. In order to use the queue, the NIC stores events on the queue. Each event is of a predefined form and may indicates information such as received data together with its source, the content of RDMA read or write commands received by the NIC, and information regarding the status of the NIC itself. The event may also indicate which of the transport libraries or alternatively the kernel the event is intended for. The transport libraries and/or the kernel can periodically poll the queue to identify if it holds events for them, alternatively or in addition the NIC could signal the destination entity (transport library or kernel) to indicate that there is an event for it on the queue. On finding an event for itself on the queue, an entity can process that event and delete it from the queue.

The queue may have one or more read or write pointers to indicate where data is next to be read or written, which can be updated by the transport libraries and/or the kernel and/or the NIC as they add or remove events from the queue.

Thus, when the NIC receives data from a remote source that is intended for processing by an application it can apply that data to the queue and signal the transport library associated with that application that the data has arrived. The transport library can then pass the data to the application.

This is satisfactory if the received data is traffic data that is intended for use by the application, for example data from a remote source that has been requested by the application itself. In that situation it does not matter if the application or the transport library is slow to access the queue (e.g. because the application and the transport library have been descheduled) since the data will not be used until the application is enabled to process it. However, if the received data is a request from a remote device to access data by means of the application: for instance an RDMA read request, then that remote device will be delayed if the request is not serviced promptly. For that reason, the NIC is arranged to identify such requests and to signal both the relevant transport library and the kernel when such an event is applied to the queue. Since the kernel is always operational it can thus be arranged that the event will be processed promptly.

An RDMA read instruction comprises data identifying it as an RDMA read instruction, and an identification of the memory address(es) from which the read should be performed, in the form of a specification of a start address and a specification of the length of data to be read from the memory following that location. The format of RDMA instructions is given in the RDMA specification, which is available from www.rdmaconsortium.org.

There are several ways in which the event could be processed. One option is for the kernel to action the read request itself. Another option is for it to access the queue, identify which transport library the request is intended for and then trigger that transport library to process the request immediately.

The kernel could be arranged to access process the event immediately on receiving the signal. However, that would involve the kernel processing read requests even if the relevant transport library were able to do so promptly. Alternatively, the kernel could be arranged to process the event only if it has remained on the event queue for longer than a predetermined time.

The kernel and/or the transport libraries may be signalled by means of an interrupt on the host device that is applied by the NIC. Alternatively, a dedicated area in RAM could be provided to hold a flag that indicates the signal. The interrupt and/or flag can be cleared when it has been actioned by the kernel or transport library.

Instead of signalling the kernel to handle the events another process that has a relatively high priority (such that it will be able to handle the events promptly) could be used.

Whilst this example has been described with reference to RDMA, it could be applied to other protocols. The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A network interface device for connection to a data processing device and to a data network so as to provide an interface between the data processing device and the network for supporting the delivery of packets of a transport protocol, the network interface device configured to:
transmit at least some of the content of the packets to the data processing device;
identify within the payloads of the packets data of a further protocol that represent a request to access memory of the data processing device; and
upon identifying such data, apply a signal to a high priority processing function of the data processing device to enable that function to process the data.

2. A network interface device as claimed in claim 1, wherein the high priority processing function is part of an operating system of the data processing device.

3. A network interface device as claimed in claim 2, wherein the high priority processing function is a kernel of the data processing device.

4. A network interface device as claimed in claim 1, wherein the said signal is an interrupt on the data processing apparatus.

5. A network interface device as claimed in claim 1, wherein the further protocol is the RDMA (remote direct memory access) or ISCSI (internet small computer serial interface) protocol.

6. A network interface device as claimed in claim 1, wherein the network interface device is arranged to transmit the packets to the data processing device by writing the packets to a queue stored by the data processing device.

7. A network interface device as claimed in claim 1, wherein the said at least part of the content comprises the whole of the payload of the packets.

8. A data processing system comprising:
a data processing device;
a data network; and
a network interface device configured
to communicate with a data processing device over the data network;
transmit at least some of the content of the packets to the data processing device;
identify within the payloads of the packets data of a further protocol that represent a request to access memory of the data processing device; and
upon identifying such data, apply a signal to a high priority processing function of the data processing device to enable that function to process the data.

9. A data processing system as claimed in claim 8, wherein the data processing device has an operating system and the operating system is arranged to accept and action the said signal.

10. A data processing system as claimed in claim 9, wherein the signal comprises data characterising the request to access memory of the data processing device and the operating system is arranged to action the said signal in accordance with that data.

11. A data processing system as claimed in claim 10, wherein the data includes data indicating the or each address at which data is to be accessed.

12. A method for connecting a network interface device to a data processing device and to a data network so as to provide an interface between the data processing device and the network for supporting the delivery of packets of a transport protocol, wherein the packets comprise payload, the method comprising:
transmitting at least some content of the packets to the data processing device;
identifying, within the payloads of the packets, data of a further protocol that represents a request to access memory of the data processing device; and
upon identifying such data, applying a signal to a high priority processing function of the data processing device to enable that function to process the data.

13. The method of claim 12, wherein the high priority processing function is part of an operating system of the data processing device.

14. A network interface device as claimed in claim 13, wherein the high priority processing function is a kernel of the data processing device.

15. A network interface device as claimed in claim 12, wherein said signal is an interrupt on the data processing apparatus.

16. A network interface device as claimed in claim 12, wherein the further protocol is the RDMA (remote direct memory access) or ISCSI (internet small computer serial interface) protocol.

17. A network interface device as claimed in claim 12, wherein the network interface device transmits the packets to the data processing device by writing the packets to a queue stored by the data processing device.

18. A network interface device as claimed claim 12, wherein said at least part of the content comprises the whole of the payload of the packets.
